(19) United States
(12) Patent Application Publication
(10) Pub. No.: US 2011/0196740 A1
(43) Pub. Date: Aug. 11, 2011

(54) Credit Card with E-paper Display for Advertisement

(76) Inventor: Yang Pan, Singapore (SG)

(21) Appl. No.: 12/701,554

(22) Filed: Feb. 6, 2010

(51) Int. Cl. G06Q 30/00; G06K 19/00; G06K 7/00

(52) U.S. Cl. 705/14.53; 705/14.4; 235/380; 235/487

(57) ABSTRACT

A novel credit or charging card is disclosed. According to one implementation, the card comprises an e-paper type of display on at least one of two surfaces of the card. An advertising message may be displayed. The advertising message may be replaced by a new one when the card is connected to a card reader. According to one embodiment of the invention, the card and the reader are connected wirelessly. RF power provided by the card reader powers an operation of refreshing the displayed message. The advertising message may be based upon a user's profile, the purchase history and the location as defined by the card reader.

### CROSS-REFERENCE TO RELATED APPLICATIONS

Not applicable.

### BACKGROUND

1. Field of Invention

This invention relates generally to advertising. More specifically, the invention describes an advertising system based on an improved credit card with e-paper display.

2. Description of Prior Art

Consumer purchasing worldwide extends into the trillions of dollars annually. Much of this commercial activity is a by-product of massive advertisement efforts whose annual cost reaches well into high billions of dollars. A significant influence on developing effective advertising is to deliver advertising messages to targeted customers.

Advertising messages delivered to the customers by using communication networks and mobile devices have become more popular in recent years. It increases the effectiveness of an advertisement by identifying a user's personal profile and his or her locations.

The use of financial transaction cards such as, for example, credit cards have become common place in virtually every aspect of consumerism. It is not un-usual that a person carries multiple cards in his or her wallet. The credit card operators possess valuable data about a user's purchasing profile. The use of the data has not been fully explored partly due to concerns about privacy. The surfaces of the cards are typically printed with the logo of the card such as “Visa” or “Master”. Some cards may be printed with advertising messages that are typically indifferent to different users.

Therefore, it is desirable to employ the financial transaction cards to deliver targeted advertising messages by utilizing the user's personal profile, purchase history and locations.

### SUMMARY OF THE INVENTION

It is an object of the present invention to provide an improved advertising system to users of financial transaction cards. The advertising messages are delivered to and displayed on the cards based upon the user's personal profile, purchase history and location.

According to a preferred embodiment of the present invention, credit cards with e-paper displays are used as exemplary cases of the present invention. The advertising system comprises a credit card, a card reader, a server operated by a card operator and an advertiser. The e-paper can display a message and/or an image without consuming electrical power when the content is not changed.

The credit card and the reader are connectable through a RFID type of system according to one implementation of the present invention. The advertising messages may be transmitted from the reader to the card when they are connected. A RF power receiver in the credit card receives RF power from the card reader. The received power is then utilized to refresh the displayed messages or images.

The messages may be delivered from a server in a communication network to the card readers. The messages may be based upon a data file in the server. The data file may comprise the user's personal profile, his or her purchase history. The messages may also be selected based on the location of the user defined by the card reader.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram illustrating an exemplary advertising system based upon the present invention;

FIG. 2 is a schematic diagram illustrating exemplarily that advertising messages are displayed on both surfaces of a credit card with e-paper displays;

FIG. 3 is a schematic diagram illustrating the connection between the card and the card reader;

FIG. 4a is a schematic diagram illustrating functional blocks of the credit card and the card readers based upon the present invention;

FIG. 4b is a schematic diagram illustrating functional blocks of the credit card with an on card power supply;

FIG. 5 is a flowchart illustrating the operation of the advertising system;

FIG. 6 is a flowchart illustrating a process that a targeted advertising message is delivered to the user using the advertising system.

### DETAILED DESCRIPTION

References will now be made in detail to a few embodiments of the invention, examples of which are illustrated in the accompanying drawings. While the invention will be described in conjunction with the particular embodiments, it will be understood that it is not intended to limit the invention to the described embodiments. To the contrary, it is intended to cover alternatives, modifications, and equivalents as may be included within the spirit and scope of invention as defined by the appended claims.

The present disclosure uses a credit card with an e-paper display as an exemplary case to illustrate the inventive concept. The inventive concept may be applied to any other financial transaction cards and to any other types of displays, which do not consume electrical power when the displayed message or image is not altered.

A credit card is part of a system of payments named after the small plastic card issued to users of the system. It is a card entitling its holder to buy goods and services based on the holder's promise to pay for these goods and services. The issuer or the operator of the card grants a line of credit to the customer or the user from which the user can borrow money for the payment to a merchant or as cash advance to the user. The present invention can also be applied to other type of financial transaction cards such as the charging cards. A credit card is different from a charging card, where a charging card requires the balance to be paid in full each month. In contrast, credit cards allow the consumers to ‘revolve’ their balance, at the cost of having interest charged. Most credit cards are issued by credit card operators such as local banks or credit unions, and are the shape and size specified by the ISO/IEC 7810 standard as ID-1. This is defined as 85.60×53.98 mm in size.

The use of the credit card comprises an authorization step. The user pays for the purchase and the merchant submits the transaction to the operator. Electronic verification systems allow merchants to verify that the card is valid and the credit card user has sufficient credit to cover the purchase in a few seconds, allowing the verification to happen at time of purchase. The verification is performed using a credit card payment terminal or a credit card reader with a communication link to the server operated by the operator through a communication network. Data from the card is obtained from a magnetic stripe or chip on the card.

E-paper is a display technology designed to mimic the appearance of ordinary ink on paper. Unlike a conventional LCD (Liquid Crystal Display), which uses a backlight to illuminate its pixels, e-paper reflects light like ordinary paper and is capable of holding text and images indefinitely without consuming electrical power, while allowing the image to be changed later.

The advertising messages may include a text message and/or an image which are suitable to be displayed on a relatively small display screen defined by the size of the credit card.

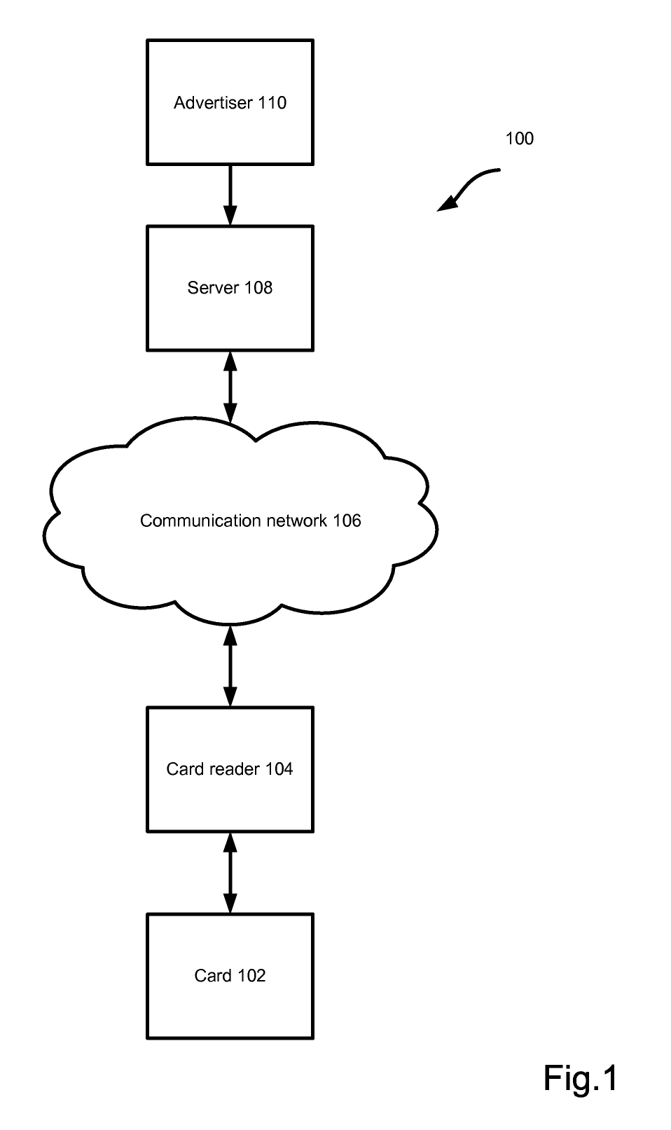

FIG. 1 is a schematic diagram illustrating an exemplary advertising system based on a credit card payment system. The system 100 comprises a credit card 102 and a card reader 104. Although one card and one card reader are depicted in the figure, the inventive concept can be extended to multiple cards and multiple card readers. The card 102 and the card reader 104 may be connectable through a wireless communication means such as for example through a RFID (Radio Frequency Identification) type of link. The card 102 and the card reader 104 may also be connectable through hard-wired connection. A communication network 106 connects the card reader to the server 108 operated by the card operator. The card operator may be an issuing bank or a credit union. The communication network 106 may be the Internet. The communication network 106 may also be public telephone networks. The server 108 may be connected to at least one advertiser 110. The advertiser 110 uploads advertising messages to the server 108.

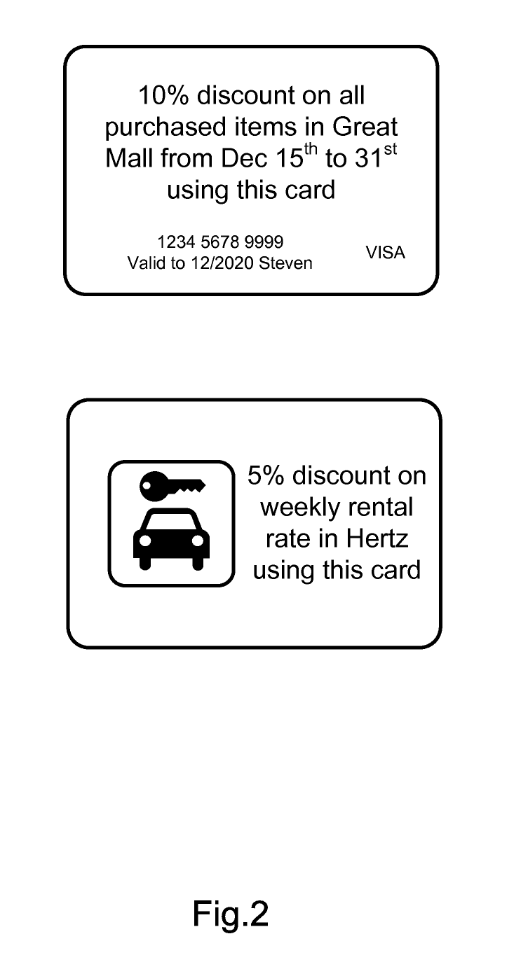

FIG. 2 is a schematic diagram illustrating exemplarily that advertising messages are displayed on surfaces of the credit card with e-paper displays. The advertising messages or images may be displayed on one surface of the card. The advertising messages or images may also be displayed on both surfaces of the card. The displayed messages or images may include a promotion specifically related to using the card as illustrated. The e-paper display is reflective and no electrical power is consumed if the messages or the images are not altered. The advertising messages may be selected based on the user's personal profile, the purchase history and the location as defined by the card reader when the message is delivered.

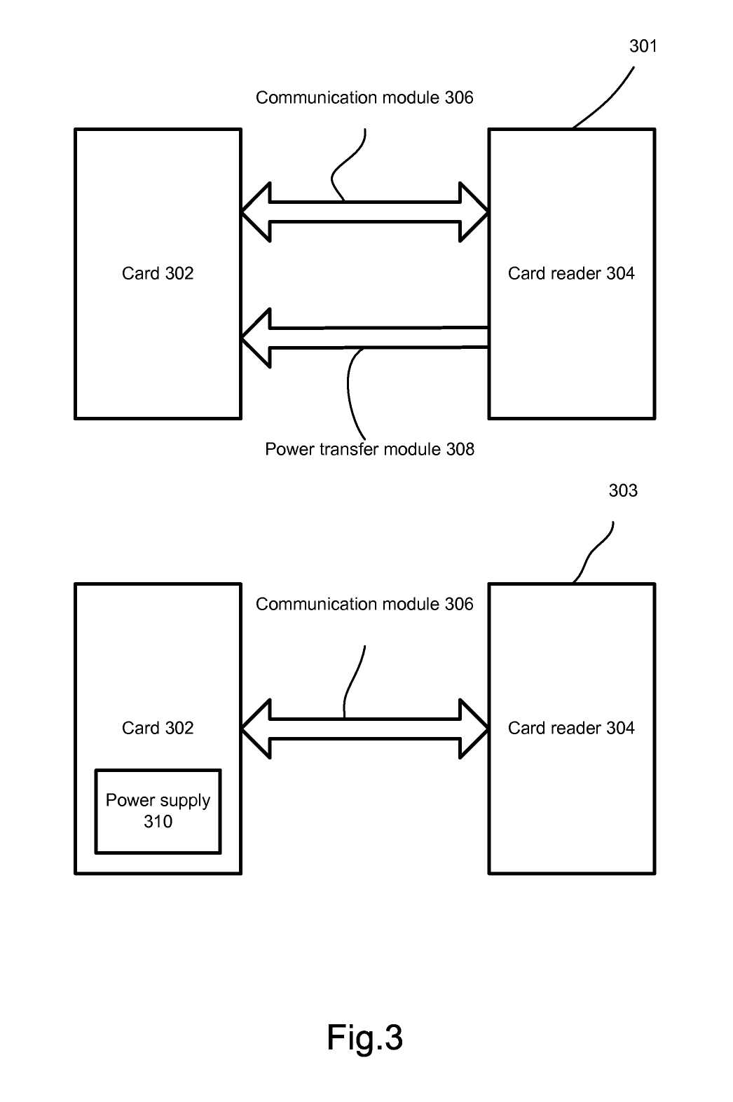

FIG. 3 is a schematic diagram illustrating the connection between the card and the card reader. According to one embodiment of the present invention as illustrated in 301, the card 302 and the card reader 304 are connected through a communication module 306 and a power transfer module 308. According to one aspect of the invention, the communication module may be a wireless communication link such as the RFID type of communication link. The other wireless communication link such as Bluetooth, ZigBee and WiFi may also be employed. The communication module 306 may also be a hard-wired communication channel when the card 302 and the reader 304 are connected.

According to one aspect of the invention, the power transfer module 308 may be a RF power transfer means similar to the one used in RFID system. The card reader 304 comprises a RF power generator and the card 302 comprises a RF power receiver. The received power is used to refresh the displayed content of the e-paper displays.

The power transfer module 308 may also be implemented using optical method. The card reader 304 may comprise a light source and the card may include a photodiode. The photodiode receives the light beam emitted from the reader and converts the received photo energy into electrical power based on the well known photovoltaic effects.

According to another embodiment of the present invention as illustrated in 303, the card 302 comprises an on card power supply 310. The power supply 310 may be a miniature battery. The power supply 310 may also be a small solar panel on at least one of the two surfaces of the card.

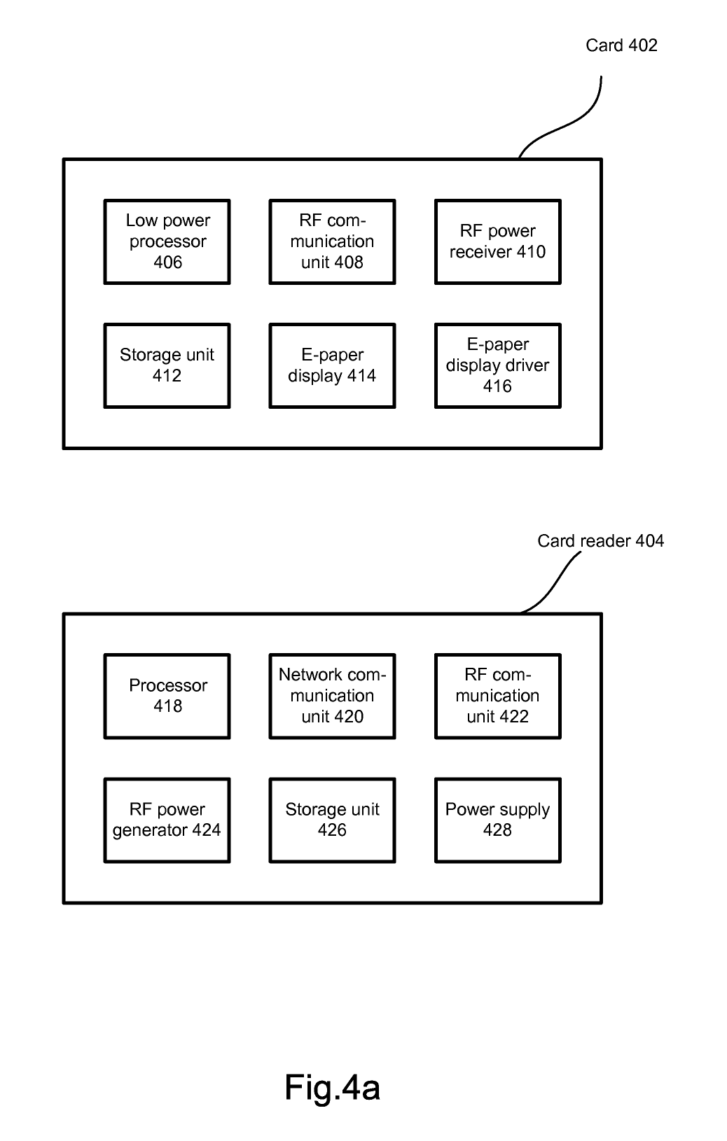

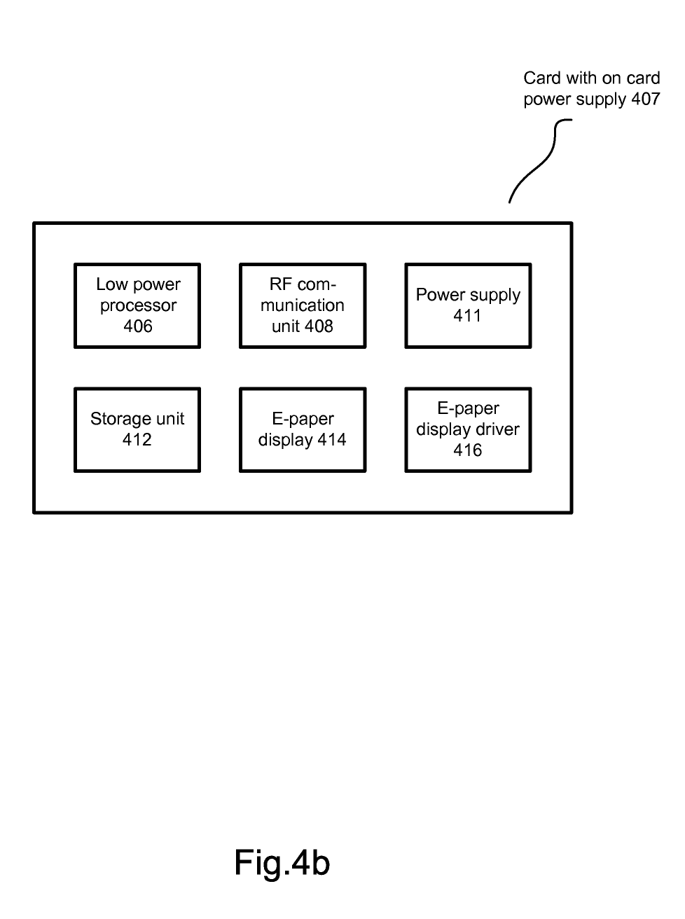

FIG. 4a is a schematic diagram illustrating functional blocks of the credit card 402 and the card reader 404 based upon the present invention. The block 402 is an exemplary implementation of the credit card 302. The exemplary card 402 comprises a low power processor 406 pertaining to control the operations of the card 402. 406 may further comprise a microprocessor or microcontroller. The card 402 further comprises a RF communication unit 408 and a RF power receiver 410. The communication unit 408 and the power receiver 410 may be implemented according to a conventional RFID system. The RF power receiver 410 receives the RF power generated from the reader 404 and rectifies the received power into a DC component to power the operations of the card 402. The card 402 may further include a storage unit 412 for storing data. The storage unit may be a nonvolatile memory such as a flash memory or an EEPROM. The card 402 further comprises a display 414. The display 414 may be a display with an electrically replaceable content on one surface of the card. The display 414 may be on both surfaces of the card. The display 414 is e-paper type of displays according to the preferred embodiment. The card 402 may also include a display driver 416.

The card reader 404 comprises a processor 418 pertaining to control the operations of the reader. The card reader 404 further comprises a network communication unit 420 for connecting the reader 404 and the server operated by the card operator through a communication network. The card reader 404 further comprises a RF communication unit 422 for connecting the reader 404 and the card 402. A RF power generator 424 is also included in 404. The card reader 404 further comprises a storage unit 426 and a power supply 428.

FIG. 4b is another implementation of the credit card based on the present inventive concept. The card 407 includes an on card power supply 411. The power supply 411 may be a miniature battery. Because the e-paper displays consume electrical power only when they change their display contents, the battery may last very long time. The power supply may also be a solar panel on one of the two surfaces of the card. The credit card 407 with on card power supply may refresh its displays controlled by the low power processor on a regular base. The advertising messages may be stored in the storage unit 412. The messages may be downloaded from the card reader when the card and the reader are connected.

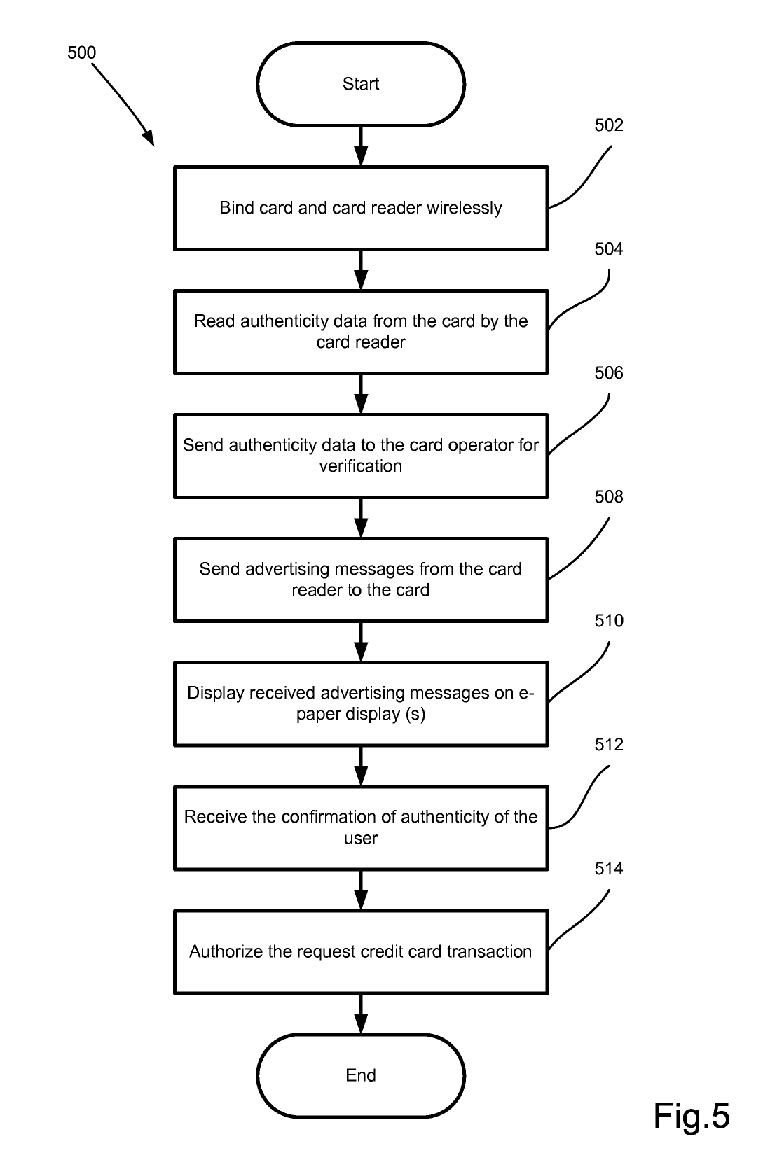

FIG. 5 is a flowchart illustrating the operation of the advertising system. Process 500 starts with step 502 that the credit card and the card reader are connected wirelessly such as through a RF type of link. The authenticity data in the card is read by the card reader in step 504. The received data is then sent to the card operator for verification in step 506. While the reader is waiting for the verification from the operator, the reader sends advertising messages to the card in step 508. The received advertising messages are displayed on e-paper displays in step 510. The operation may be controlled by the low power processor of the card and the display driver. The card reader finally receives the confirmation of the authenticity of the user in step 512 and the credit card transaction for the purchase is completed in step 514. It should be noted that the credit card may also fail the authenticity check and the transaction will not be authorized when it happens.

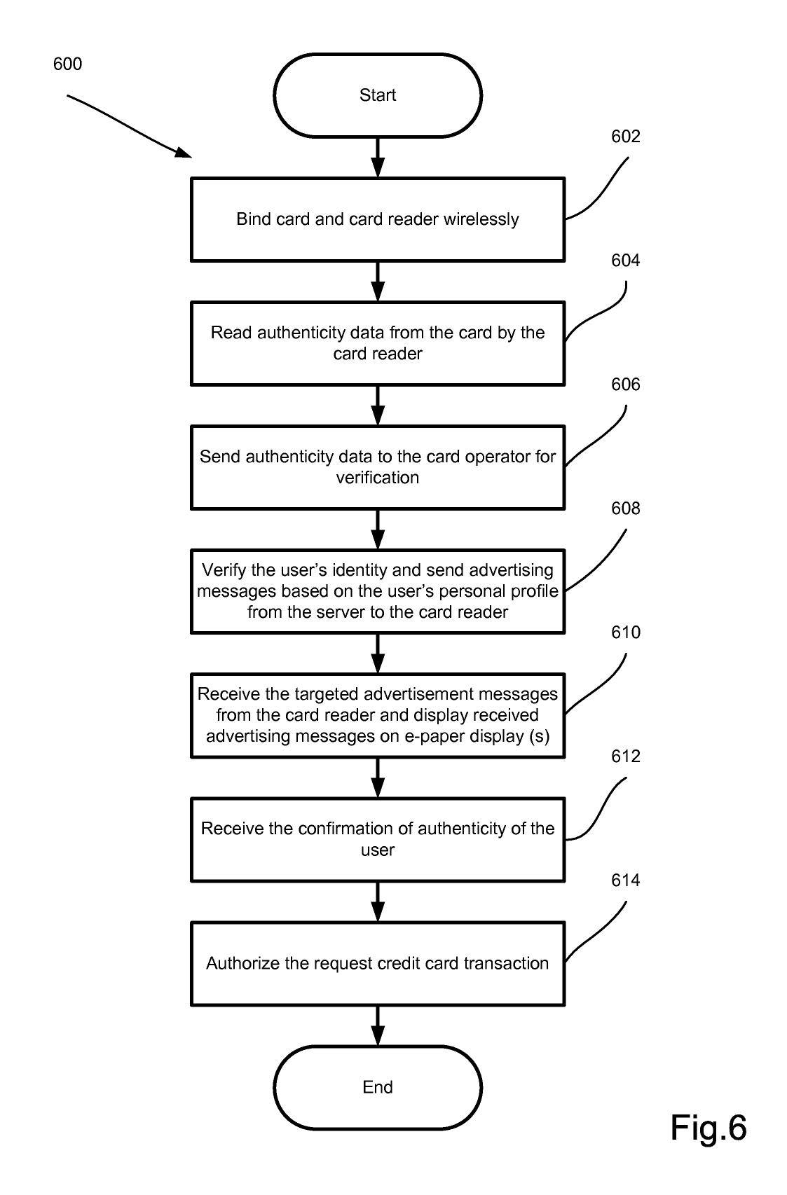

FIG. 6 is a flowchart illustrating a process that a targeted advertising message is delivered to the user using the advertising system. Process 600 starts with step 602 that the credit card and the card reader are connected wirelessly such as through a RF type of link. The authenticity data in the card is read by the card reader in step 604. The received data is then sent to the card operator for verification in step 606. The user's authenticity is determined in step 608 and advertising messages based on the user's personal profile, purchase history and the location of the reader are sent to the card reader accordingly. The messages are received in step 610 by the card reader. The messages are sent to the card subsequently and are displayed on the e-paper displays. In the same time, the reader receives the confirmation of the authenticity of the user in step 612 and authorizes the transaction in step 614.

1. An advertising message delivery system comprising:
a. a credit or a charging card with an electrically replaceable display at least on one surface;
b. a card reader; and
c. a server,
wherein said card and said card reader are connectable through a communication link and said server and said card reader are connectable through a communication network.

2. The system as recited in claim 1, wherein said display further comprising an e-paper type of display.

3. The system as recited in claim 1, wherein said communication link further comprising a wireless communication link including a RF communication link.

4. The system as recited in claim 1, wherein said communication link further comprising a wired communication link.

5. The system as recited in claim 1, wherein said card further comprising a power supply.

6. The system as recited in claim 5, wherein said power supply further comprising a power supply unit selected from the following group:
a. a RF power receiver;
b. a battery; and
c. a photo energy collecting device.

7. The system as recited in claim 1, wherein said card further comprising:
a. a low power processor;
b. a storage unit; and
c. a display driver.

8. The system as recited in claim 1, wherein said system further comprising one or a plurality of advertisers that are connectable to said server.

9. The system as recited in claim 1, wherein said communication network comprising the Internet or public telephone networks.

10. A method of delivering an advertising message to a user of a credit or a charging card comprising an electrically replaceable display on at least one surface of the card, the method comprising:
a. binding the card and a card reader;
b. receiving the advertising message by the card from the reader; and
c. displaying received advertising message.

11. The method as recited in claim 10, wherein said method further comprising a step of receiving power from said reader for powering operation of said card.

12. The method as recited in claim 11, wherein said power transferred from the reader may be in a form of RF power or photo energy.

13. The method as recited in claim 10, wherein said advertising message may be selected based upon:
a. the user's personal profile; and/or
b. the user's purchase history; and/or
c. the user's present location as defined by the location of the card reader.

14. The method as recited in claim 10, wherein said method further comprising a step of transferring the advertising message from a server to the card reader, wherein the server and the card reader are connected through a communication network including the Internet or public phone networks.

15. The method as recited in claim 10, wherein said advertising message including a commercial incentive associated with the use of said card.

16. A credit or a charging card comprising a display with an electrically replaceable image on at least one of two surfaces of the card.

17. The card as recited in claim 16, wherein said display further comprising an e-paper type of display.

18. The card as recited in claim 16, wherein said card further comprising a wireless communication unit.

19. The card as recited in claim 16, wherein said card further comprising a power supply.

20. The card as recited in claim 19, wherein said power supply further comprising a power supply unit selected from the following group:
a. a RF power receiver;
b. a battery; and
c. a photo energy collecting device.
